(19) United States
(12) Patent Application Publication
(10) Pub. No.: US 2008/0187213 A1
(43) Pub. Date: Aug. 7, 2008

(54) Fast Landmark Detection Using Regression Methods

(75) Inventors: Cha Zhang, Sammamish, WA (US); Paul Viola, Redmond, WA (US); Sang Min Oh, Atlanta, GA (US)

Correspondence Address: MICROSOFT CORPORATION;C/O LYON & HARR, LLP, 300 ESPLANADE DRIVE, SUITE 800, OXNARD, CA, 93036, US

(73) Assignee: Microsoft Corporation, Redmond, WA (US)

(21) Appl. No.: 11/671,760

(22) Filed: Feb. 6, 2007

(51) Int. Cl. G06K 9/62

(52) U.S. Cl. 382/159

(57) ABSTRACT

A landmark detection technique that can quickly detect both objects of interest and landmarks within the objects in an image using regression methods. The present fast landmark detection scheme reuses existing feature values used for object detection (e.g., face detection) to find the landmarks in an object (e.g., the eyes and mouth of the face). Hence, the technique provides landmark detection functionality at almost no cost.

### BACKGROUND

Face detection systems generally operate by scanning an image for regions having attributes which would indicate the region contains a person's face. These regions are extracted and compared to training images depicting people's faces (or representations thereof).

Learning-based methods have so far been the most effective ones for face detection. In learning-based methods, it is assumed that human faces can be described by some low-level features which may be derived from a set of prototype or training face images. From a pattern recognition viewpoint, two issues are essential in face detection: (i) feature selection, and (ii) classifier design in view of the selected features. The learning process is often very computationally expensive and demands huge amount of training data, though the detection process can be relatively efficient. Most of the computation during detection is on the computation of the selected features. Unfortunately these features are usually discarded once the objects are detected in an input image.

Another aspect of face detection and recognition involves detecting landmarks in the detected faces. Detecting facial landmarks such as eyes and the corners of a mouth have many potential applications including face pose estimation, virtual makeup, and low bandwidth teleconferencing for example. Traditional landmark detection algorithms often build separate classifiers for detecting landmarks, which also tends to be very computationally expensive.

### SUMMARY

The present fast landmark detection technique can quickly detect both objects of interest and landmarks within the objects in an input image using regression methods. The present technique accomplishes this task by reusing existing feature values computed for object or face detection to find the landmarks in an object or face. Hence, the present technique provides landmark detection functionality at almost no cost.

More particularly, the present fast landmark detection technique employs a trained object detector that uses features to determine if an object can be detected in an input image. The object detector outputs any detected object in the input image and provides the feature values used in the detection process. These feature values (possibly with some additional features) are input into a trained regressor. The regressor is trained using regression methods using these feature values to detect landmarks (e.g., the mouth, nose, eyes) in any object detected by the object detector. These regression methods can, for example, include any of the following: mean prediction, linear regression, a neural network, additive polynomial modeling, and a boosted or regular regression tree. Additionally, each of these regression methods can be used with raw or transformed (for example, by using thresholding) feature values, as well as the raw pixel values. Once the landmarks are detected they can be used for various applications such as face pose estimation, virtual makeup, and low bandwidth teleconferencing, for example.

It is noted that while the foregoing limitations in existing landmark detection schemes described in the Background section can be resolved by a particular implementation of the present fast landmark detection technique, this is in no way limited to implementations that just solve any or all of the noted disadvantages. Rather, the present technique has a much wider application as will become evident from the descriptions to follow.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In the following description of embodiments of the present disclosure reference is made to the accompanying drawings which form a part hereof, and in which are shown, by way of illustration, specific embodiments in which the technique may be practiced. It is understood that other embodiments may be utilized and structural changes may be made without departing from the scope of the present disclosure.

### DESCRIPTION OF THE DRAWINGS

The specific features, aspects, and advantages of the disclosure will become better understood with regard to the following description, appended claims, and accompanying drawings where:

FIG. 1 is a diagram depicting a general purpose computing device constituting an exemplary system for a implementing the present fast landmark detection technique.

FIG. 2 is a diagram an exemplary architecture wherein the present fast landmark detection technique can be practiced.

FIG. 3 is a flow diagram depicting one exemplary embodiment of the present fast landmark detection technique.

FIG. 4 is a flow diagram depicting another exemplary embodiment of the present fast landmark detection technique.

FIG. 5 is a block diagram depicting the Viola-Jones face detector employed in one embodiment of the present fast landmark detection technique.

### DETAILED DESCRIPTION

### 1.0 The Computing Environment

Before providing a description of embodiments of the present fast landmark detection technique, a brief, general description of a suitable computing environment in which portions thereof may be implemented will be described. The present technique is operational with numerous general purpose or special purpose computing system environments or configurations. Examples of well known computing systems, environments, and/or configurations that may be suitable include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

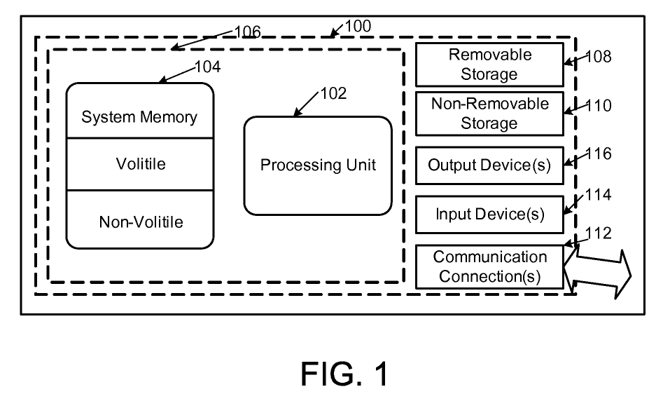

FIG. 1 illustrates an example of a suitable computing system environment. The computing system environment is only one example of a suitable computing environment and is not intended to suggest any limitation as to the scope of use or functionality of the present sound source localization technique. Neither should the computing environment be interpreted as having any dependency or requirement relating to any one or combination of components illustrated in the exemplary operating environment. With reference to FIG. 1, an exemplary system for implementing the present fast landmark detection technique includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106. Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

Device 100 may also contain communications connection(s) 112 that allow the device to communicate with other devices. Communications connection(s) 112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Device 100 may also have other input device(s) 114 such as keyboard, mouse, microphone, pen, voice input device, touch input device, and so on. Output device(s) 116 such as a display, speakers, a printer, and so on may also be included. All of these devices are well known in the art and need not be discussed at length here.

Device 100 can include a camera as an input device 114 (such as a digital/electronic still or video camera, or film/photographic scanner), which is capable of capturing a sequence of images, as an input device. Further, multiple cameras could be included as input devices. The images from the one or more cameras can be input into the device 100 via an appropriate interface (not shown). However, it is noted that image data can also be input into the device 100 from any computer-readable media as well, without requiring the use of a camera.

The present fast landmark detection technique may be described in the general context of computer-executable instructions, such as program modules, being executed by a computing device. Generally, program modules include routines, programs, objects, components, data structures, and so on, that perform particular tasks or implement particular abstract data types. The present fast landmark detection technique may also be practiced in distributed computing environments where tasks are performed by remote processing devices that are linked through a communications network. In a distributed computing environment, program modules may be located in both local and remote computer storage media including memory storage devices.

The exemplary operating environment having now been discussed, the remaining parts of this description section will be devoted to a description of the program modules embodying the present fast landmark detection technique.

2.0 Fast Landmark Detection Technique

The following paragraphs discuss an exemplary operating environment, exemplary architectures and processes employing the fast landmark detection technique, and details regarding the various embodiments.

2.1 Exemplary Operating Architecture

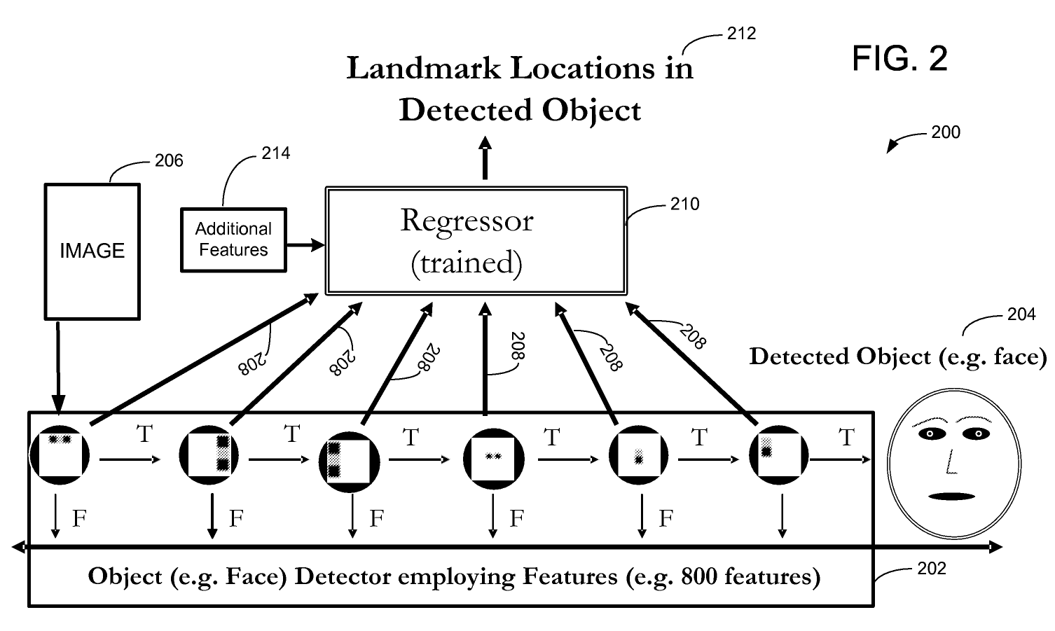

FIG. 2 depicts an exemplary architecture 200 in which the present fast landmark detection technique can be practiced. The architecture 200 employs a trained object detector 202 that uses features to determine if an object 204 can be detected in an input image 206. For example, in one embodiment the object detector could be a face detector that employs a cascade detector structure and the objects detected could be people's faces. Besides outputting any detected object 204, the object detector also provides the feature values 208 that were used in the detection process. These feature values 208 (and possibly with other features 214) are input into a trained regressor 210. The regressor is trained using any of a number of regression methods (e.g., mean prediction, linear regression, neural network, additive polynomial modeling, boosted or regular regression tree) to detect landmarks (e.g., mouth, nose, eyes) in a detected object, such as a face, using the feature values determined by the object detector. Once the landmarks are detected they can be used for various applications such as face pose estimation, virtual makeup, and low bandwidth teleconferencing, for example.

More particularly, in the present fast landmark detection technique, simple image feature values that are obtained in object detection, are used to train a regressor to locate the landmarks within an object detected. Once trained, the regressor is used to detect landmarks in input images in which an object is detected by the object detector.

In one embodiment of the fast landmark detection technique, the object detector and the features used are similar to those used in the well known Viola-Jones face detector. These features, which will be described in greater detail below, can be computed very quickly. The values of the features used in detecting faces in the face detector can then be reused in determining landmark features in the faces. The landmark features can be described using the regression relationship shown in the equation below.

$$[ \begin{matrix}{o}_{1} \\ {o}_{2} \\ {o}_{3} \\ {o}_{4}\end{matrix} ] = [ \begin{matrix}{l}_{11} & {l}_{12} & {l}_{13} & {l}_{14} \\ {l}_{21} & {l}_{22} & {l}_{23} & {l}_{24} \\ {l}_{31} & {l}_{32} & {l}_{33} & {l}_{34} \\ {l}_{41} & {l}_{42} & {l}_{43} & {l}_{44}\end{matrix} ] \times [ \begin{matrix}{i}_{1} \\ {i}_{2} \\ {i}_{3} \\ 1\end{matrix} ]$$

$$where$$

$${l}_{ij} = \frac{\partial {o}_{i}}{\partial {i}_{j}}$$

The left side of the equation, (i.e., the matrix containing o₁, o₂, o₃, and o₄), defines the coordinates of the landmarks in a two dimensional space (for example, o₁, o₂ could define the x and y coordinates of the left eye, respectively, while o₃, and o₄ could define the x and y coordinates of the right eye, respectively). The right side of the equation, (i.e., the matrix containing i₁, i₂, and i₃), defines the feature values obtained from the object detector (which in this case is a face detector). These features could be raw features, transformed features or image pixel values, depending on the object detector employed. Raw features are the features that are output by the object detector or face detector, such as the cascade filter outputs of the Voila face detector. Transformed features can be obtained, for example, by thresholding the scalar value of the feature, and are also typically output by the object detector. It should be noted that raw and transformed features can also be combined, or can be combined with features not obtained from the object detector, if desired. The middle matrix, (i.e., l₁₁, l₁₂, l₁₃, l₁₄, l₂₁, l₂₂, l₂₃, l₂₄, l₃₁, l₃₂, l₃₃, l₃₄, l₄₁, l₄₂, l₄₃, l₄₄) herein termed the regression matrix, contains the coefficients that need to be learned in order to define the landmark feature coordinates in terms of the known feature values provided by the object detector.

### 2.2 Exemplary Fast Landmark Detection Process

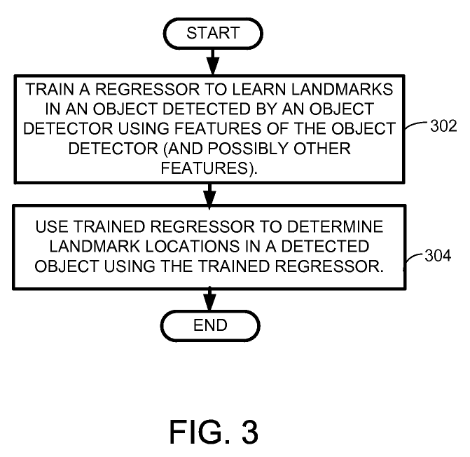

One embodiment of a process implementing the fast landmark detection technique is shown in FIG. 3. A regressor is first trained to learn landmark features in an object that is detected by an object detector using the feature values provided by the object detector (as well as other features possibly) (block 302). Once the regressor is trained, as shown in block 304, it is used to determine the location of landmarks in an object detected by the object detector.

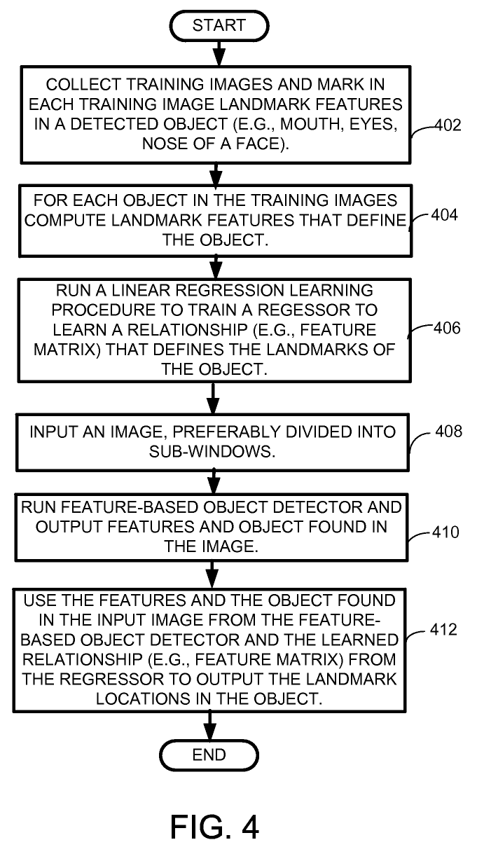

A more detailed flow diagram of this embodiment is shown in FIG. 4. Blocks 402, 404 and 406 are related to the training of the regressor, while blocks 408, 410 and 412 are related to employing the trained regressor to detect both an object and the landmarks in any detected objects. As shown in block 402, training images are collected to be used in training the regressor to determine the location of landmarks in an object detected by an object detector. In one working embodiment, this training data base was obtained by using a web crawler to crawl the World Wide Web to collect 2000 images containing faces. Once these images are collected, they are labeled with ground truth landmark locations (e.g., in the aforementioned working embodiment 6000 faces found in the training images and the eye/nose/mouth locations of the detected faces were marked), as shown in block 404. The captured training images are also preprocessed to prepare them for input into the regressor. In general, this involves normalizing and cropping the training images. Additionally, the training images are roughly aligned by using the eyes and mouth. Normalizing the training images preferably entails normalizing the scale of the images by resizing the images. It is noted that this action could be skipped if the images are captured at the desired scale thus eliminating the need for resizing. The desired scale for the face is approximately the size of the smallest face region expected to be found in the input images being searched. These normalization actions are performed so that each of the training images generally matches as to orientation and size. The training images are also preferably cropped to eliminate unneeded portions of the image which could contribute to noise in the training process. It is noted that the training images could be cropped first and then normalized. Once the training images are preprocessed, they are used to train the regressor to identify where the coordinates of the landmark locations are in the training images give the feature values associated with each training image, as shown in block 406.

Once the regressor is trained it can be used to detect landmarks in any image detected by an object detector. To this end, an image is input, preferably divided into sub-windows, as shown in block 408. To divide the input image into sub-windows, a moving window approach can be taken where a window of a prescribed size is moved across the input image, and at prescribed intervals, all the pixels within the sub-window become the next image region to be tested for an object such as a face. For a tested embodiment of the present fast landmark detection technique a window size of 29 by 29 pixels was chosen for an image size of 640 by 480 pixels. Of course, many or all of the landmarks depicted in the input image may be smaller or larger than the aforementioned window size. This may be solved by searching a series of increased scale or decreased scale sub-windows. For example, the original sub-window size can be increased by some scale factor (in a tested embodiment this scale factor was 1.25) in a step-wise fashion all the way up to the input image size itself, if desired. After each increase in scale, the input image is partitioned with the search sub-window size. Various methods of creating sub-windows in searching for the landmarks can be used, as are well known in the art.

A feature-based object detector is run on the image, or each sub-window thereof, and the features used and any object found in the image or sub-windows are determined, as shown in block 410. The features and object found in the input image or sub-window are input into the trained regressor which then determines the locations of any landmarks found in the detected object, as shown in block 412. Blocks 408, 410, 412 can then be repeated for any additional images that are input for which landmark locations are to be found.

Exemplary embodiments of the present architecture and processes of the present fast landmark detection technique having been explained, the following paragraphs provide additional details.

2.3 Features and Object Detector

The present fast feature detection technique employs a conventional trained object detector and the features it extracts. It is known that given a feature set and a training set of positive and negative images any number of machine learning approaches can be used to learn a classification function. Various conventional learning approaches can be used to train the classifiers of an object detector, e.g. Gaussian model, a small set of simple image features and a neural network or a support vector machine. The face object detector preferably classifies images based on the value of simple features. It preferably uses a combination of weak classifiers derived from tens of thousands of features to construct a powerful detector. A weak classifier is one that employs a simple learning algorithm (and hence a fewer number of features). Weak classifiers have the advantage of allowing for very limited amounts of processing time to classify an input. The object detector classifies an image sub-window into either an object or non-object (e.g., face or non-face). In one embodiment, each detector is constructed based on boosting the performance of the weak classifiers by using a boosting procedure, while each weak classifier is taught from statistics of a single scalar feature.

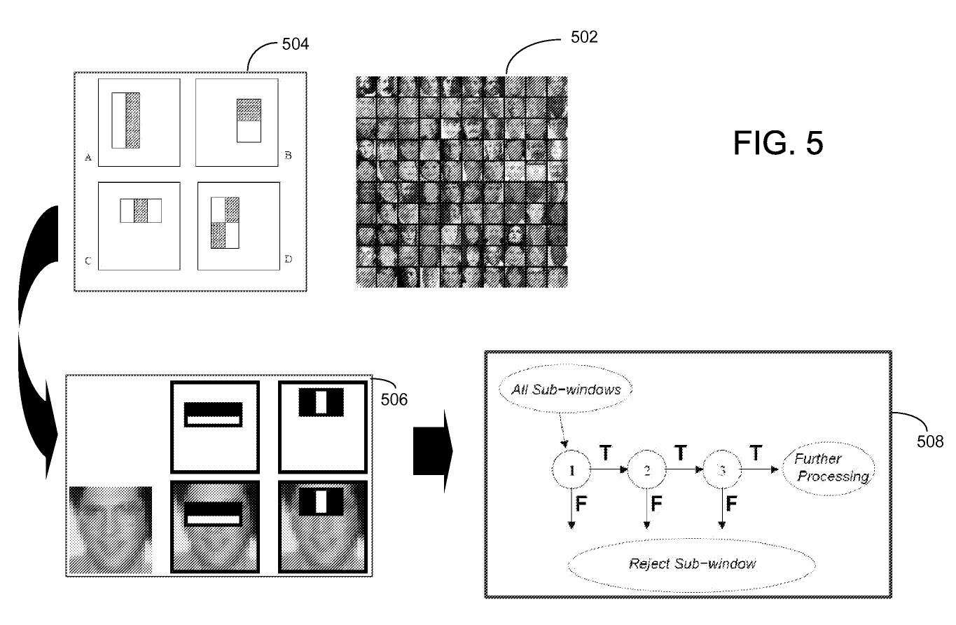

In one embodiment of the present fast landmark detection technique the well known Viola-Jones face detector is employed to detect faces. As shown in FIG. 5, a training image data set is used to train the Viola-Jones detector. In the Viola-Jones face detector, simple Haar-like features 504, are extracted. Sequential feature selection then takes place (block 506), using the well known Adaboost boosting procedure to construct a cascade face detector (block 508). In the Voila-Jones face detector, face/non-face classification is done by using a cascade of successively more complex classifiers which are trained by using the well-known (discrete) AdaBoost learning algorithm. Hence, the face/nonface classifier is constructed based on a number of weak classifiers where a weak classifier performs face/non-face classification using a different single feature, e.g. by thresholding the scalar value of the feature according the face/non-face histograms of the feature. A detector can be one or a cascade of face/nonface classifiers. Each feature has a scalar value which can be computed very efficiently via summed-area table or integral image methods. Once the detector is constructed and trained, it can be used to determine if each sub-window of an input image is a face or a non-face window. For every sub-window that is a non-face, it will not be considered as it passes to the later detectors in the cascade.

2.4 Regression Methods

As discussed previously, various regression methods can be used to train the regressor to detect landmark features in an object. Although these regression methods are well known, the following paragraphs provide some explanation of the methods that can be used.

Linear Regression: Linear regression is a regression method of modeling the conditional expected value of one variable y given the values of some other variable or variables x. In the case of the present fast landmark detection technique linear regression is used to learn a linear regression matrix that contains the coefficients that need to be learned in order to define the landmark feature coordinates in terms of the known feature values provided by an object detector.

Neural Network: A neural network may also be used to learn the coefficients needed to define the landmark feature coordinates in terms of the known feature values provided by an object detector. A neural network is a computational method for optimizing for a desired property based on previous learning cycles (e.g., training). It consists of an interconnected assembly of simple processing elements, units or nodes. The processing ability of the network is stored in the inter-unit connection strengths, or weights, obtained by a process of adaptation to, or learning from, a set of training patterns.

Additive Polynomial Modeling: Additive polynomial modeling is another regression method that can be used to define the landmark features in terms of the known feature values. The learning process recursively selects features from the ones used by the object detector and uses a polynomial representation of that feature to additively approximate the landmark feature coordinates.

Regression Tree/Boosted Regression Tree: Decision and regression trees are well known examples of machine learning techniques. In most general terms, the purpose of the analyses via tree-building algorithms is to determine a set of if-then logical conditions that permit accurate prediction or classification of cases. Tree classification techniques produce accurate predictions or predicted classifications based on few logical if-then conditions. The general tree approach to derive predictions from a few simple if-then conditions can be applied to regression problems as well and this type of a decision tree is called a regression tree. Regression trees can also be boosted. Boosted regression trees are those that apply boosting methods to regression trees. The concept of boosting applies to the area of predictive data mining, to generate multiple models or classifiers (for prediction or classification), and to derive weights to combine the predictions from those models into a single prediction or predicted classification. Boosting will generate a sequence of classifiers, where each consecutive classifier in the sequence is an “expert” in classifying observations that were not well classified by those preceding it. During classification of new cases the predictions from the different classifiers can then be combined to derive a single best prediction or classification.

Mean Prediction: Mean prediction is the simplest method for landmark detection, which takes all the training data's mean coordinates as the prediction of the location for any test object.

It should also be noted that any or all of the aforementioned embodiments throughout the description may be used in any combination desired to form additional hybrid embodiments.

Wherefore, what is claimed is:

1. A computer-implemented process for detecting landmarks and their positions in an object detected in an input image, comprising using a computer to perform the following process actions:
creating a database comprising a plurality of training feature characterizations, each of which characterizes features of an object in an image;
for each object in the database computing landmark features that define the object and defining the ground truth locations of these landmark features;
training a regressor using a regression learning procedure to learn a relationship that defines the location of landmarks in any detected object given said feature characterizations;
inputting a portion of an input image into an object detector and outputting the location of any object found in the portion of the input image and feature characterizations used to find any object found;
inputting the feature characterizations and the location of any object found in the portion of the input image to into the trained regressor to output the landmark locations.

2. The computer-implemented process of claim 1 wherein the regression learning procedure comprises employing linear regression.

3. The computer-implemented process of claim 1 wherein the regression learning procedure comprises employing a neural network.

4. The computer-implemented process of claim 1 wherein the regression learning procedure comprises employing additive polynomial modeling.

5. The computer-implemented process of claim 1 wherein the regression learning procedure comprises employing a regression tree.

6. The computer-implemented process of claim 1 wherein the feature characterizations are raw feature values output from the object detector.

7. The computer-implemented process of claim 1 wherein the feature characterizations are transformed feature values output from the object detector.

8. The computer-implemented process of claim 1 wherein the feature characterizations are raw pixel values output from the object detector.

9. The computer-implemented process of claim 1 wherein the object detector is a face detector and wherein the landmarks are the eyes, nose and mouth of any face detected by the face detector.

10. A computer-readable medium having computer-executable instructions for performing the process recited in claim 1.

11. A system for locating landmarks in an object detected by an object detector, comprising:
a general purpose computing device;
a computer program comprising program modules executable by the general purpose computing device, wherein the computing device is directed by the program modules of the computer program to,
input an object in an image detected by an object detector that employs features to detect the object, and the features used to detect the object, into a regressor trained to find the locations of landmarks in the object; and
output the locations of the landmarks in the object.

12. The system of claim 11 wherein the object detector is a face detector.

13. The system of claim 11 wherein the regressor is trained using a regression procedure.

14. The system of claim 13 wherein the regression procedure comprises at least one of:
mean prediction;
linear regression;
a neural network;
additive polynomial modeling;
a regression tree; and
a boosted regression tree.

15. The system of claim 11 wherein the output landmarks are used for one of:
face pose estimation;
virtual makeup application; and
teleconferencing.

16. A computer-implemented process for training a regressor to detect landmarks and their positions in a face detected in an input image and using the trained regressor, comprising using a computer to perform the following process actions:
creating a training database of faces;
for each face in the training database computing landmarks that define the face and marking the ground truth locations of these landmarks; and
training a regressor using a regression learning procedure and the training database with the defined ground truth locations and features used by the face detector to learn a matrix that defines the landmarks in any detected face.

17. The computer-implemented process of claim 16 further comprising using the trained regressor to define the location of landmarks in a face detected by the face detector, comprising:
inputting a portion of an input image into an face detector and outputting the location of any face found in the portion of the input image and features used to find any face found;
inputting the features and the location of any face found in the portion of the input image to into the trained regressor to output the landmark locations.

18. The computer-implemented process of claim 17 wherein the regression procedure comprises employing a neural network and wherein the features are pixel values.

19. The computer-implemented process of claim 17 wherein the regression procedure comprises employing a regression tree and wherein the features are raw or transformed features.

20. The computer-implemented process of claim 19 wherein the regression tree is a boosted regression tree.
